(19) United States
(12) Patent Application Publication
(10) Pub. No.: US 2003/0219256 A1
(43) Pub. Date: Nov. 27, 2003

(54) Optical signal transmission system and transmitter

(76) Inventors: Farhad Hakimi, Watertown, MA (US); Hosain Hakimi, Watertown, MA (US); Darius Subacius, Groton, MA (US)

Correspondence Address: HALE AND DORR, LLP, 60 STATE STREET, BOSTON, MA, 02109

(21) Appl. No.: 10/211,709

(22) Filed: Aug. 2, 2002

Related U.S. Application Data
(60) Provisional application No. 60/382,848, filed on May 23, 2002.

(51) Int. Cl. H04B 10/12

(52) U.S. Cl. 398/149

(57) ABSTRACT

An optical communication system and method are disclosed. Optical communication may be implemented with less complicated and costly components yet use RZ-like signal formats. The method may also be adapted to provide communication with beneficial phase relationships among optical pulses. An originating signal has a plurality of pulses, each pulse defined by a leading edge and a falling edge. A plurality of first optical pulses are created and transmitted on an optical communication medium in which each first optical pulse corresponds to a leading edge of a corresponding pulse of the originating signal. A plurality of second optical pulses are created and transmitted on an optical communication medium in which each second optical pulse corresponds to a falling edge of a corresponding pulse of the originating signal.

### CROSS-REFERENCE TO RELATED APPLICATIONS

This application claims the benefit of U.S. Provisional Application No. 60/382,848, entitled “All Optical NRZ to RZ Format Conversion Using an Interferometer” filed on May 23, 2002, which is hereby incorporated by reference in its entirety.

### BACKGROUND

1. Field of the Invention

This invention generally relates to optical communication and in particular to optical communication systems and methods using a RZ-like format of an underlying data signal.

2. Discussion of Related Art

Return-to-Zero (RZ) format has certain benefits over Not Return-to-Zero (NRZ) for fiber optic communication. One advantage of RZ stems from the fact that RZ pulses are less prone to effects of non linearity in the fiber, such as self phase modulation (SPM). Hence RZ format results in more robust communications. Additionally, the RZ format can support soliton transmission that has shown better tolerance to a particular impairment in the fibers, called polarization mode dispersion (PMD). (See U.S. patent application Ser. No. 10/138,717, filed May 3, 2002, assigned to the assignees of this application, which is hereby incorporated by reference in its entirety.)

However, the components needed to generate RZ format requires higher electrical (RF) and optical bandwidth (e.g., 25% to 50%). This, in turn, translates to higher complexity and cost. As the data rates increases, the bandwidth needed to generate RZ signals increases as well, complicating the task.

### SUMMARY

The invention provides improved optical communication that attains certain benefits found with RZ communication but which avoids the typical complexity and cost. The invention, among other things, provides an optical transmitter and optical communication system.

According to one aspect of the invention, optical communication is provided, by a transmitter and a receiver. The transmitter is coupled to an input and it receives a stream of binary pulses from an input. The transmitter includes an NRZ circuit and an edge encoding circuit. The NRZ circuit provides an NRZ signal in response to the stream of binary pulses. The NRZ signal has a rising signal edge corresponding to a change of data state in the stream of binary pulses and a falling signal edge corresponding to an opposite change of data state in the stream of binary pulses. The edge encoding circuit is coupled to the optical signal medium and provides an optical signal stream encoding of the NRZ signal. The optical signal stream has an optical pulse corresponding to the rising signal edge of the NRZ signal and another optical pulse for the falling signal edge of the NRZ signal. The receiver is coupled to the optical signal medium and has a decoding circuit for providing the stream of binary pulses in response to the optical signal stream received from the optical signal medium.

According to another aspect of the invention, the edge encoding circuit is an optical circuit.

According to another aspect of the invention, the optical pulse and the other optical pulse have a predetermined phase difference therebetween.

According to another aspect of the invention, the phase difference is about π radian.

According to another aspect of the invention, the edge encoding circuit includes an interferometer having two legs in which one leg has a time delay relative to the other, and wherein the time delay is a fraction of the data period of the stream of binary pulses.

According to another aspect of the invention, the edge encoding circuit includes a Fabry Perot interferometer operating in a reflection mode.

According to another aspect of the invention, the decoding circuit includes a toggle circuit responsive to the optical signal stream. A first pulse causes the toggle circuit to attain a first data state and the toggle circuit retains that data state until it receives a second pulse. Thus, the toggle circuit provides a NRZ representation of the optical signal stream.

### BRIEF DESCRIPTION OF THE DRAWINGS

In the Drawing,

FIG. 1 is a block diagram of exemplary transmission components according to certain embodiments of the invention;

FIG. 2 illustrates various signal formats according to certain embodiments of the invention; and

FIG. 3 illustrates an optical communication system, including receiver components according to certain embodiments of the invention.

### DETAILED DESCRIPTION

Preferred embodiments of the present invention generate an RZ-like signal, passively via all optical conversion of an NRZ signal. The RZ-like signal is not a RZ format of the underlying data signal but is an RZ version of an NRZ form of the underlying data signal. The RZ-like signal has beneficial phase relationships among the pulses. As will be explained below, preferred embodiments do not require the complicated, costly, high-bandwidth components necessary for conventional RZ communication.

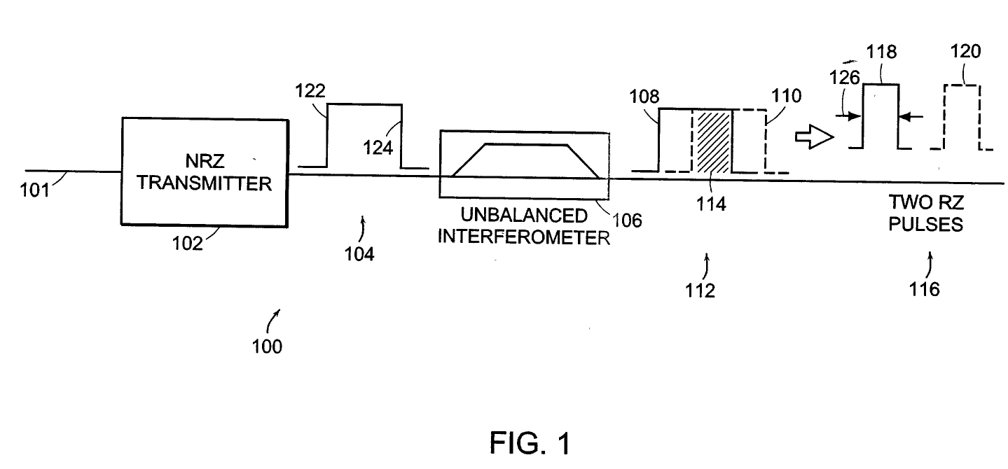

FIG. 1 is a block diagram of an exemplary system 100 according to certain embodiments of the invention. A data signal is provided to NRZ transmitter 102, which emits an optical NRZ signal 104. NRZ signal 104 is fed into an unbalanced interferometer 106 with one arm delayed relative to other preferably by about half the bit period of the data signal and with one arm phased set at preferable π radian relative to the other. (The time delay is preferably a fraction of a bit period.) One arm of the unbalanced interferometer 106 creates a pulse 108 and the other arm creates a pulse 110 that is time-overlapping and phase-shifted relative to the other. The superimposed pulses are depicted conceptually by 112. As indicated by the shaded area 114, the two pulses 108, 110 each have portions that destructively interfere. As shown conceptually, by detail 116, the result of the destructive interference is two RZ-like pulses 118, 120.

As will be explained below, the two pulses 118, 120 are not necessarily RZ representation of the underlying data signal fed into transmitter 102. Instead, the pulses 118, 120 in effect encode the rising edge 122 and falling edge 124 of the NRZ signal 104. The duration 126 of these generated RZ-like pulses 118, 120 is determined by the delay in the interferometer 106. By adjusting the delay, the time overlap of pulse 108, 110 change, with the resulting width 126 of the non-interfering portions also changing. The RZ-like signal 116 is less prone to fiber impairments such as SPM and PMD than is the NRZ signal. Moreover, the generated signal 116 has Carrier Suppressed RZ spectrum (CSRZ). This is caused by π phase difference pulses generated in the output of the interferometer 106. CSRZ is known to be more robust to cross talks such as cross phase modulation (XPM) and four wave mixing (FWM) in a Wavelength Division Multiplexed (WDM) system.

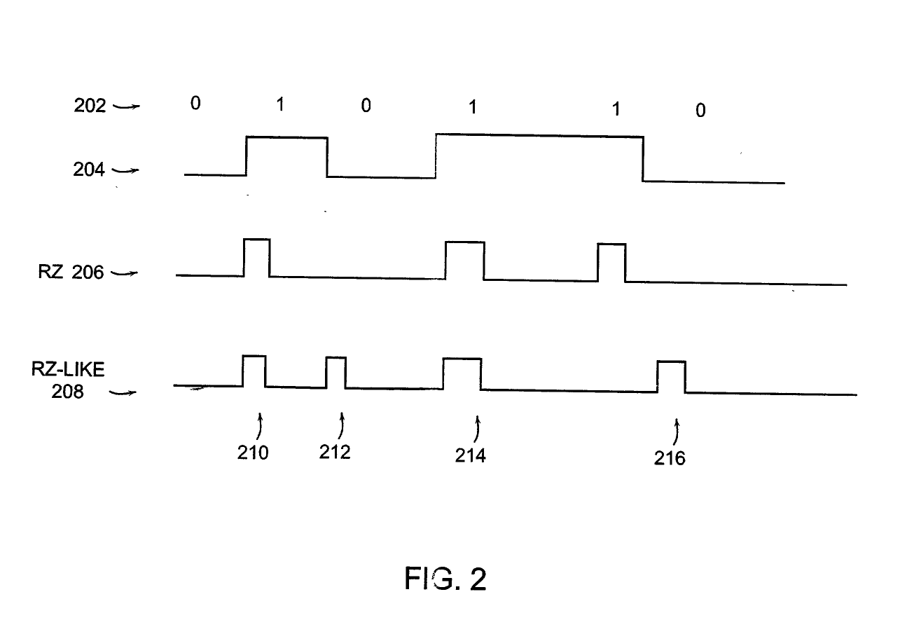

FIG. 2 illustrates the signal formats. An exemplary underlying data signal 202 is shown as a binary stream. A NRZ version thereof is shown as 204. A conventional RZ signal of the underlying signal 202 is shown as 206. An RZ-like signal created by certain embodiments of the invention is shown as 208. Note RZ-like signal 208 differs from conventional RZ signal 206. Under exemplary embodiments, leading pulses 210, 214 correspond to leading edges of the corresponding NRZ signal 204. Trailing pulses 212, 216 correspond to trailing edges of the corresponding NRZ signal 204. The leading and corresponding trailing pulses preferably have a phase difference of π.

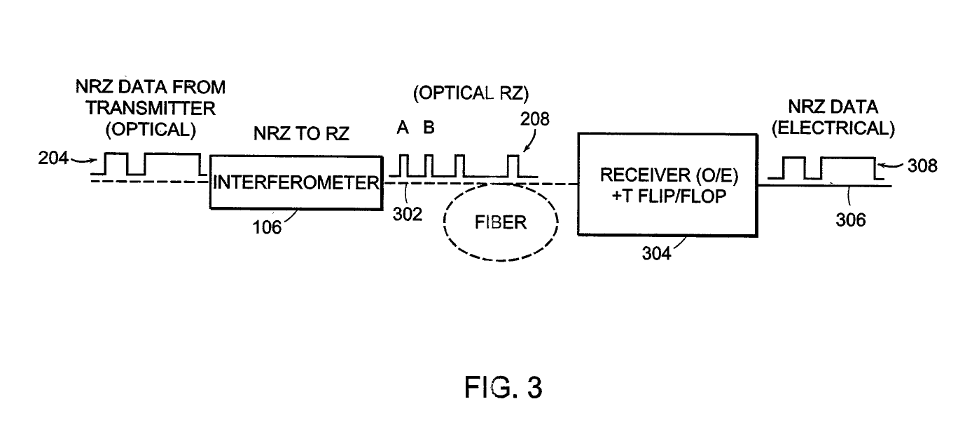

FIG. 3 illustrates a communication system including the transmission system described above and including a receiver 304. An optical NRZ signal 204 is received by the interferometer 106, like those described above. The interferometer produced an RZ-like signal 208, as described above and transmits such over fiber 302. (Fiber is shown conceptually; various repeaters and the like being omitted for simplicity.) The signal 208 is then received by optical receiver 304.

Receiver 304 performs an Optical to Electrical conversion (O/E) of the received signal 208 to create an electrical version thereof (e.g., same pulse shape and duration but in electrical domain). The electrical version of the signal 208 is then processed, in certain embodiments, using a toggle flip-flop (T flip-flop) circuit (not shown). With such a circuit, a pulse (or leading edge thereof) changes the state of the output of the circuit (i.e., the state toggles). The output remains in that state until another pulse is received, which toggles the state again. That is, upon arrival of any RZ pulse at the toggle circuit, the toggle circuit output changes state from 0 to 1 or from 1 to 0, depending on the state of the circuit when the pulse arrives. The result of such an operation is that the RZ-like signal 208 when processed by the toggle circuit creates a reconstitution of the NRZ signal 204, but in the electrical domain. This is illustrated by NRZ signal 308, which is emitted on electrical link 306. This signal may then be processed using conventional circuitry to reconstitute the original underlying signal 204.

Many forms of unbalanced interferometers may be used. For example, Michelson interferometers (MIs) and Mach Zehnder interferometers (MZIs) may be used. Among other things, such approaches may allow tuning of time delay and phase shift, as is known in the art.

In an alternative embodiment, the pulse replicator described in U.S. patent application Ser. No, not yet assigned, entitled “System and Method of Replicating Optical Pulses”, filed on even date herewith, assigned to the assignees of this invention, and naming Hosain Hakimi and Farhad Hakimi as inventors (which is hereby incorporated by reference in its entirety) may be used in place of unbalanced interferometer 106. The round trip time of Fabry Perot interferometer operating in reflection mode determines the delay between the pulses, and the phase difference between the replicated pulses may be adjusted as discussed therein. In certain embodiments, the delay would be approximately on half the bit period, and the phase difference would be approximately π.

It will be further appreciated that the scope of the present invention is not limited to the above-described embodiments, but rather is defined by the appended claims, and that these claims will encompass modifications of and improvements to what has been described.

What is claimed is:

1. A system for optical communication, comprising:
an optical signal medium;
a transmitter, coupled to an input for receiving a stream of binary pulses, the transmitter having an NRZ circuit and an edge encoding circuit, the NRZ circuit providing an NRZ signal responsively to the stream of binary pulses in which the NRZ signal has a rising signal edge corresponding to a change of data state in the stream of binary pulses and a falling signal edge corresponding to an opposite change of data state in the stream of binary pulses, the edge encoding circuit being coupled to the optical signal medium and providing thereon an optical signal stream encoding of the NRZ signal, the optical signal stream having an optical pulse corresponding to the rising signal edge of the NRZ signal and another optical pulse for the falling signal edge of the NRZ signal; and
a receiver coupled to the optical signal medium and having a decoding circuit for providing the stream of binary pulses in response to the optical signal stream received from the optical signal medium.

2. The system of claim 1 wherein the edge encoding circuit is an optical circuit.

3. The system of claim 1 wherein the edge encoding circuit provides the optical pulse and the other optical pulse with a predetermined phase difference therebetween.

4. The system of claim 3 wherein the phase difference is about π radian.

5. The system of claim 1 wherein the edge encoding circuit includes an interferometer having two legs in which one leg has a time delay relative to the other, and wherein the time delay is a fraction of the data period of the stream of binary pulses.

6. The system of claim 5 wherein the interferometer has a tunable time delay between the two legs.

7. The system of claim 5 wherein the interferometer has a tunable phase delay between the two legs.

8. The system of claim 1 wherein the edge encoding circuit includes a Fabry Perot interferometer operating in a reflection mode.

9. The system of claim 1 wherein the decoding circuit includes a toggle circuit responsive to the optical signal stream in which a first pulse causes the toggle circuit to attain a first data state and wherein the toggle circuit will retain that data state until it receives a second pulse, wherein the toggle circuit thereby provides a NRZ representation of the optical signal stream.

10. The system of claim 9 wherein the receiver includes an optical to electrical conversion circuit and wherein the electrical output is provided to the toggle circuit.

11. The system of claim 9 wherein the receiver further includes a data conversion circuit responsive to the NRZ representation and providing a binary pulse stream in response thereto.

12. A transmitter for optical communication, comprising:
an input for receiving a stream of binary pulses,
an NRZ circuit providing an NRZ signal responsively to the stream of binary pulses in which the NRZ signal has a rising signal edge corresponding to a change of data state in the stream of binary pulses and a falling signal edge corresponding to an opposite change of data state in the stream of binary pulses; and
an edge encoding circuit coupled to the optical signal medium and providing thereon an optical signal stream encoding of the NRZ signal, the optical signal stream having an optical pulse corresponding to the rising signal edge of the NRZ signal and another optical pulse for the falling signal edge of the NRZ signal.

13. The transmitter of claim 12 wherein the edge encoding circuit is an optical circuit.

14. The transmitter of claim 12 wherein the edge encoding circuit provides the optical pulse and the other optical pulse with a predetermined phase difference therebetween.

15. The transmitter of claim 14 wherein the phase difference is about π radian.

16. The transmitter of claim 12 wherein the edge encoding circuit includes an interferometer having two legs in which one leg has a time delay relative to the other, and wherein the time delay is a fraction of the data period of the stream of binary pulses.

17. The transmitter of claim 16 wherein the interferometer has a tunable time delay between the two legs.

18. The transmitter of claim 16 wherein the interferometer has a tunable phase delay between the two legs.

19. The transmitter of claim 12 wherein the edge encoding circuit includes a Fabry Perot interferometer operating in a reflection mode.
